(19) United States
(12) Patent Application Publication
(10) Pub. No.: US 2011/0259892 A1
(43) Pub. Date: Oct. 27, 2011

(54) Telescoping Cryocane

(75) Inventors: Eric Cognard, Fontenay Les Louvets (FR); Juan Moreno, Navasota, TX (US)

(73) Assignee: ST REPRODUCTIVE TECHNOLOGIES LLC, Navasota, TX (US)

(21) Appl. No.: 13/092,684

(22) Filed: Apr. 22, 2011

Related U.S. Application Data
(60) Provisional application No. 61/327,050, filed on Apr. 22, 2010.

(51) Int. Cl. F17C 3/00; B65D 25/22

(52) U.S. Cl. 220/560.11; 220/737

(57) ABSTRACT

A telescoping cryocane having a first container element and a second container element, for suspending smaller containers upright within a cryogenic container. The first container element and the second container element can be in a slidable telescoping relationship. One or more of the first and the second container elements can be configured for suspending and retaining the smaller containers at very low temperatures.

### FIELD

The present embodiments generally relate to the field of containers, and more particularly, relate to telescoping cryocanes for transporting and/or storing cryopreserved materials such as biological materials.

### BACKGROUND

Biological materials, such as tissues or cells, can be suspended in order to maintain the viability cells with limited shelf lives. For example, biological materials can be cryopreserved prior to shipment or storage in order to reduce biological activity and biochemical reactions that can result in, or lead to, cell death. Cryopreservation can be carried out in a number of ways, and can include storing cells in the presence of a cryogenic liquid. Liquid nitrogen, for example, changes from liquid phase to a gas phase at −196 C and is widely used to maintain materials below about −150 C. However, the packaging required to store or ship cryogenic fluid is significantly more cumbersome that the packaging required to ship biological materials alone.

Several containers exist for shipping and storing cryopreserved materials, such as reproductive cells. Generally, these containers resemble cumbersome metal tanks with large internal volumes for housing cryopreserved materials alongside cryogenic fluids. The tanks can include double walled metal cryostats for reducing heat exchanges with ambient air. Certain reproductive cells, such as frozen sperm, or frozen sex-sorted sperm, are often packaged in relatively small 0.25 ml straws that can be suspended near the liquid nitrogen to maintain low temperatures. The straws can be about 10-15 cm long with a diameter of about between 2 and 4 mm. In order to provide some organization to the straws in a tank and to prevent the straws from sitting in a pile submerged in liquid nitrogen, cryocanes have been developed to stand upright in these tanks and hold vials or containers which in turn hold pluralities of straws upright within the container.

The cryocanes can provide an elongate rigid structure with arms for holding two small containers or vials. Straws can be placed into each of the two containers providing two rows of straws per cryocane.

While the cryocanes are suitable for storage in large tanks, which are more common in storing cryogenic materials, but a significant problem exists when transferring the cryocanes into smaller volume containers because the smaller volume containers may have less depth, making the rigid cryocanes awkward for transfer or even unable to be transferred. In particular, shipping containers for shipping cryogenically preserved materials have become smaller and lighter in recent years with the introduction of dryshipping materials and methods. A dryshipping container can include a doubled walled Dewar vessel partially filled with an absorbent material within a shipping container. The absorbent material can be saturated with liquid nitrogen and shipping materials can be stored within the Dewar vessel surrounded by the refrigerant. These containers can be designed for shipment and weigh significantly less than the large metal cryostat storage tanks, but may not be able to receive the long cryocanes designed for access within the large storage tanks. This can be problematic in light of the fact that cryopreserved materials need to be maintained at their low temperatures and time outside of cryogenic containers can result in significant warming. Therefore, a substantial problem exists with respect to existing cryocanes because they require large cumbersome tanks and a need exists for cryocanes which are transferable between different containers.

Another substantial problem exists in that cryocanes of a set length may be too long for fitting in some containers, and may be too short for accessibility in other containers. Therefore, a need exists for a cryocane capable of fitting in a variety of shipping and storage containers having a variety of interior dimensions. In the event straws or smaller containers holding straws are removed from a cryocane, there exists a risk of losing identifying information from the cryocane. Additionally, such intermediate steps increase exposure to elevated temperatures.

### SUMMARY OF THE INVENTION

Accordingly, a broad object of the invention can be to provide a telescoping cryocane adjustable from a first retracted position to a second extended position for fitting into a variety of cryogenic containers. In one aspect such a cryocean can be adjustable to one position for storage in a cryogenic storage container, such as an extended position, and adjustable into another configuration for placement in a shipping container, such as a retracted position.

Another broad object of the invention can be to provide a telescoping cryocane with an adjustable length for accessibility from a variety of cryogenic containers.

Naturally, further objects of the invention are disclosed throughout other areas of the specification, drawings and claims.

### A BRIEF DESCRIPTION OF THE DRAWINGS

FIG. 1A illustrates an isometric view of a telescoping cryocane according to certain embodiments of the present invention.

FIG. 1B illustrates an isometric view of a portion of a telescoping cryocane according to certain embodiments of the present invention.

FIG. 1C illustrates an isometric view of a portion of a telescoping cryocane according to certain embodiments of the present invention.

FIG. 2A illustrates an isometric view of a telescoping cryocane according to certain embodiments of the present invention.

FIG. 2B illustrates an isometric view of a telescoping cryocane according to certain embodiments of the present invention.

FIG. 3A illustrates an isometric view of a telescoping cryocane according to certain embodiments of the present invention.

FIG. 3B illustrates a cross sectional view of the telescoping cryocane illustrated in FIG. 3A.

FIG. 3C illustrates a cross sectional view of the telescoping cryocane illustrated in FIG. 3A.

FIG. 4 illustrates an isometric front view of a telescoping cryocane according to certain embodiments of the present invention.

### DETAILED DESCRIPTION OF THE PREFERRED EMBODIMENTS

Before explaining the embodiments of the apparatus in detail it should be appreciated the embodiments illustrated are certain embodiments and that many alternatives are envisioned within the scope of the claimed invention. Further, features of each described embodiment should be understood as features that can be interchanged with or combined with features described separately or in separate embodiments.

One embodiment of the telescoping cryocane can include two pieces generally referred to as telescoping container elements. The first container element can have a base from which a first arm with a first distal end extends and from which a second arm with a second distal end extends. The second arm can converge toward the first arm partially enclosing an interior space forming a generally tubular shape with an interior space and a gap. Each of the arms can cooperate to form an interior surface capable of retaining and suspending a container with dimensions substantially matched to the interior space. These arms can extend towards each other in a curvilinear fashion, or can comprise a number of angled sections. By way of one non-limiting example the arms can be shaped to hold a cylindrical container with a diameter of roughly 0.5 to 10 cm, or as one example with a diameter of about 1.5 cm. The arms of the first container element can also be constructed for supporting containers with polygonal cross sections. The arms can be configured to particular containers, such as 1.8 ml vials, which can have similar diameters to the containers described above, but can be about 5 cm in length.

The second container element can slibably attach to the first container element in a telescoping relationship. The second container element can slide between an extended position and a retracted position relative to the first container element whereby in the retracted position the second container element resides substantially within the interior spaced formed by the first container element and in the extended.

In one embodiment, the second container element can resemble a cylindrical container-like structure with a bottom attached to at least one sidewall having an exterior surface. A guiding protrusion can be formed on the exterior surface of the sidewall, and the guiding protrusion can extend past the interior surface of the first arm and the second arm in the gap therebetween. In this configuration, the guiding portion of the second container element can limit the movement of the second container in all but a longitudinal direction relative to the first container element keeping the first container element in a telescoping relationship with the second container element.

The container elements can be constructed from a rigid material with enough elasticity for receiving and suspending a container. Examples of suitable materials include high density polyethylene, polycarbonates, and sufficiently stable polypropylenes. Other materials are envisioned for embodiments herein. More particularly, any material sufficiently elastic, sufficiently rigid, and capable of storage in liquid nitrogen can be used.

The telescoping movement between the first container element and the second container element can be limited in a fully extended configuration by the cooperation of a first catch formed in the first container element and a stopping surface formed in the second container element. The first catch can be formed by an extension of the first distal end and by an extension of the second distal end in the first container element. This catch can be characterized as an increasingly narrow portion of the gap. The guiding protrusion formed on the second container element can have a stopping portion with a stopping surface which contacts the first catch when the telescoping cryocane is fully extended. The guiding protrusion can also have a neck portion with a width smaller than the narrow portion of the gap allowing the sliding engagement of the second container element relative to the second container element. The arrangement allows the free longitudinal movement of the first container element relative to the second container element until the stopping surface contacts the first catch.

The telescoping movement of the first and second container elements can be limited in the retracted position by a second stopping portion formed as a flange on the bottom of the second container element. The flange can have dimensions larger than the interior spaced formed between the first and second arms such that the flange abuts the ends of the first container element.

In addition to the stops defining the limits of the telescoping longitudinal movement, each of the first container element and the second container element can include locking mechanisms to hold the first container element and the second container element in locked positions. In one embodiment the locking elements cooperate to lock the container elements in each of a fully extended and a fully retracted position. Each of the locking mechanisms can comprise a locking aperture in one container element, which aligns with a projection the other container element.

In one embodiment the first container element can include a base from which a first arm with a first distal end extends and from which a second arm with a second distal end extends. Like the previous embodiment, the distal ends of each arm can converge towards each other forming an interior space that can be capable of suspending a container. In this embodiment, the interior space can further be defined by a bottom formed on the first container element. The base can also include a plurality of first arms extending from the one side and a plurality of second arms extending from another side. The number and arrangement of arms can be organized to provide access to the content of each of the held containers or can be adjusted for containers of specific sizes. For example, in contrast to the containers for carrying straws, the arms can be configured for carrying 1 to 4 smaller vials like those used for storing embryos. The plurality of cooperating arms can retain each individual vial while permitting access for removing the vials.

In this embodiment, the first container element can include at least one guide. This guide can be formed integrally with the base, such as by a strip of material cut and raised relative to the base. This guide can receive the second container element, which can be in the form of an elongate member having a proximal end and a distal end where the elongate member slides through the guide providing the telescoping relationship between the first container element and the second container element. This elongate member can include means for holding vials or containers, or can merely provide an extension. This elongate member can include a stop at the proximal end and/or a stop at the distal end. In either case, the stops can be formed by outward protrusions with dimensions larger than those of the guide. In one embodiment the elongate member can be thought of as an extending arm with protrusions serving as limits for extending and retracting the extending arm relative to the first container element.

In one embodiment the first container element can have a longitudinal slit mating with a protrusion formed on extending arm, or elongate member. The protrusion can serve as a guide for extending and retracting the second container element where a fully extended position is defined by the protrusion of the second container element hitting a first end of the longitudinal slit in the first container element and the fully retracted position is defined when the protrusion in the second container element hits the second end of the longitudinal slit opposite the first end.

In yet another embodiment, a stopping mechanism can be employed to retain the cryocane in either of the retracted or extended positions. This stopping mechanism can incorporate a locking protrusion on the elongate member that engages a locking aperture on the first container element. The locking aperture can be located, for example, at the guide formed in the first container element. The locking protrusion and the locking aperture can be aligned such that they are engaged when the telescoping cryocane is in the fully extended position.

Another embodiment relates to a system of shipping or storing materials at low temperatures, which includes a cryogenic container containing cryogenic fluid, such as liquid nitrogen. A telescoping cryocane can be placed in the cryogenic container with a first container element holding a container with materials to be stored at low temperatures. The first container element can be extended such that the materials are in close proximity to the cryogenic fluid. The telescoping cryocane can be extended such that a second container element is accessible from the exterior of the cryogenic container.

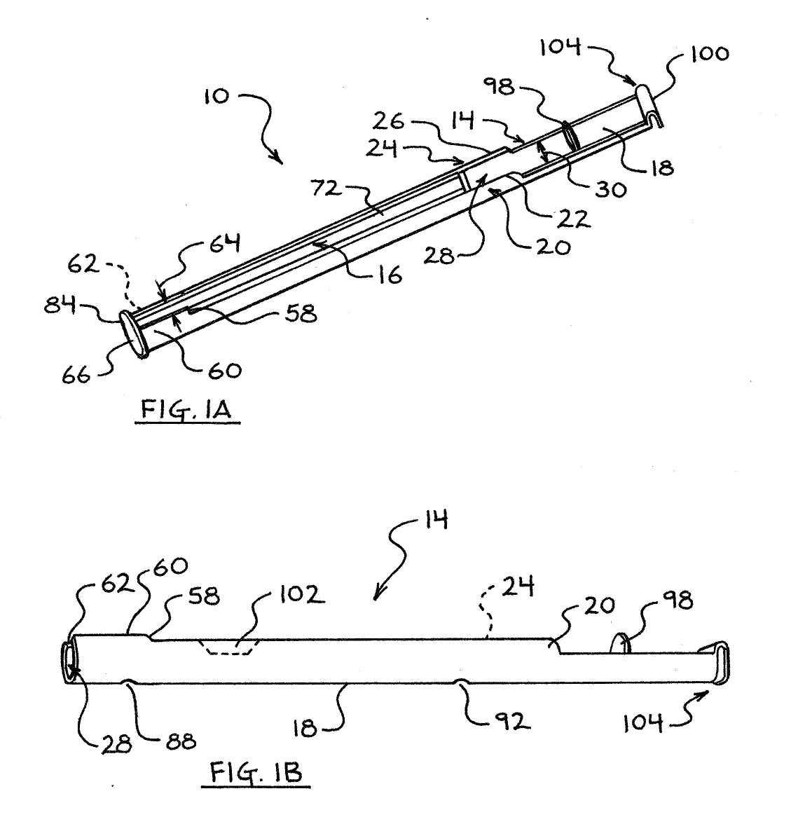

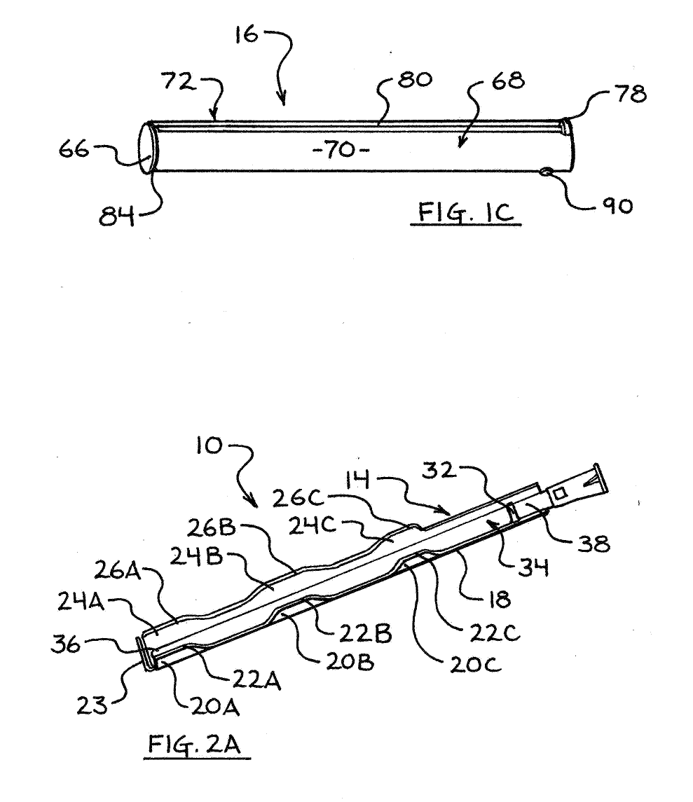

Referring now to the figures, and more particularly, to FIG. 1A-1C, an embodiment of a telescoping cryocane 10 can be seen including a first container element 14 and a second container element 16 joined in a slidable telescoping relationship. The telescoping cryocane 10 is illustrated in the fully retracted position wherein nearly the entire second container element 16 is retracted within the first container element 14. The first container element 14 can be seen as a base 18 from which a first arm 20 and from which a second arm 24 extends. Each of the first arm 20 and the second arm 24 has a first distal end 22 and a second distal end 26, respectively. The distal ends 22 and 26 are formed in a converging manner and can be configured for holding a container when the telescoping cryocane 10 is in the fully extended position. A gap 30 can be formed between the first distal end 22 and the second distal end 26. This convergence between the first arm 20 and second arm 24, in combination with the base 18, can partially enclose an interior space 28, at least partially defined by the interior surfaces of the first arm and the second arm. While in the fully retracted position the second container element 16 resides within this interior space 28. However, when the telescoping cryocane 10 is in the fully extended position (not illustrated) the interior space 28 provides a location for holding an additional container.

A first catch 58 can be formed on the first container element 14 for the purpose of limiting the extension of the second container element 14 relative to the first container element 16. This catch 58 can be formed as the combination of an extension of the first distal end 60 and an extension of the second distal end 62 which form a narrow portion of the gap 64.

Referring to FIG. 1C a view of the second container element 16 more clearly illustrates a bottom 66 and a continuous sidewall 68 with an exterior surface 70. While a cylindrical element is depicted, other shapes and configurations are envisioned having complimentary exterior surfaces 70 to the interior of the first container element 14 to facilitate the telescoping relationship between the two container elements. The shape of the continuous sidewall 68 can be complimentary to the interior surface of the first arm 20 and second arm 26. The second container element 16 can be capable of holding straws or vials of straws.

FIG. 1C also illustrates the guiding protrusion 72 extending from the exterior surface 70 which is mated with the gap 30 in FIG. 1A. The guiding protrusion 72 has a stopping surface 78 for engaging the catch 58 in the fully extended position (not illustrated), as well as a neck portion 80 which fits through both the gap 30 and the narrow portion of the gap 64 thereby permitting the telescoping relationship between the first container element 14 and the second container element 16. The second container element 16 further comprises a second stopping portion in the form of flange 84 formed on the bottom 66. The flange 84 can rest against the bottom of the first container element 14 defining the fully retracted position of the telescoping cryocane 10 and is generally dimensioned so as not to pass the bottom of the first container as defined by the first arm 20 and the second arm 26. When the flange meets the bottom of the first container element 14, the telescoping cryocane 10 is in the fully retracted position and substantially the entire second container element 16 is contained within the interior space 28 formed by the first container element 16.

A first locking mechanism can be formed between the first container element 14 and the second container element 16 in the form of a first locking aperture 88 (Seen in FIG. 1B only) in the first container element 14 which corresponds with a locking projection 90 formed in the second container element 16. This locking projection 90 can be coordinated with the first locking aperture 88 such that the two elements are in alignment when the telescoping cryocane 10 is in the fully extended position. Similarly, a second locking mechanism is formed between the locking projection 90 and a second locking aperture 92 formed in the first container element 14. The second locking aperture 92 can be coordinated on the opposite end of the second container element 16 to provide a lock mechanism when the telescoping cryocane 10 is in a fully retracted position (illustrated in FIG. 1A).

In various embodiments the telescoping cryocane 10 can include a spaced stopper 98 for retaining the contents of containers being held. In another embodiment, the first container element 16 can include a hook structure 104 that can be used for stability within various containers, such as shipping or storage containers for cryopreserved materials. This hook structure 104 can further comprise a flat top surface 100, allowing easy labeling and identification of cryocanes being stored within a storage or shipping container. In yet another embodiment, the arms of the first container element 16 can include access grooves 102 allowing access to containers or the contents of containers held in the telescoping cryocane 10. In particular, a plurality of grooves can be spaced and dimensioned to facilitate grabbing or gripping containers held within certain portions of the telescoping cryocane 10.

The first container element 14 and the second container element 16 can both be dimensioned to hold a container or vial having a diameter of about 0.5-10 cm and a length of about 8-15 cm. Each of the first container element 14 and the second container element 16 can also be dimensioned for suspending two such containers.

FIGS. 2A and 2B illustrate a telescoping cryocane 10 with a first container element 14 and a second container element illustrated as an elongate member 34 with a proximal end 36 and a distal end 38. The first container element 14 is illustrated with a plurality of first arms 20a, 20b and 20c, each having a first distal end 22a, 22b and 22c and a plurality of second arms 24a, 24b and 24c, each having a second distal end 26a, 26b and 26c. The illustrated embodiments can have corresponding first arms and second arms which are relatively symmetric, but other embodiments, such as alternating first and second arms, are envisioned so long as the arms are configured sufficiently for holding containers or other objects of interest.

A guide 32 can be seen in FIG. 2A for receiving the elongate member 34 having a proximal end 36 and a distal end 38. Stops in the form of lateral extensions can be provided at the proximal 36 and/or distal 38 ends of the elongate member 34 in order to limit the extension and retraction of the elongate member 34 relative to the first container element 14. Additionally, a bottom 23 can be provided on the first container element 14 for the purpose of supporting a container or other object of interest, as well as, to limit the retraction of the elongate member 34.

In FIG. 2B an outward protrusion 40 of the elongate member 34 is seen through a longitudinal slit 42 in the base 18 of the first container element 14. The outward protrusion 40 can include a narrow portion for passing through the longitudinal slit 42, as well as, an expanded portion for locking the elongate member 34 into relatively stable sliding communication with the first container element 14. This longitudinal slit 42 serves as a guide for both the outward protrusion 40 and the elongate member 34 by limiting retraction of the elongate member when the outward protrusion 40 arrives at the first end 46 of the longitudinal slit 42 and limiting the extension of the elongate member 34 when the outward protrusion arrives at the second end 48 of the longitudinal slit 42.

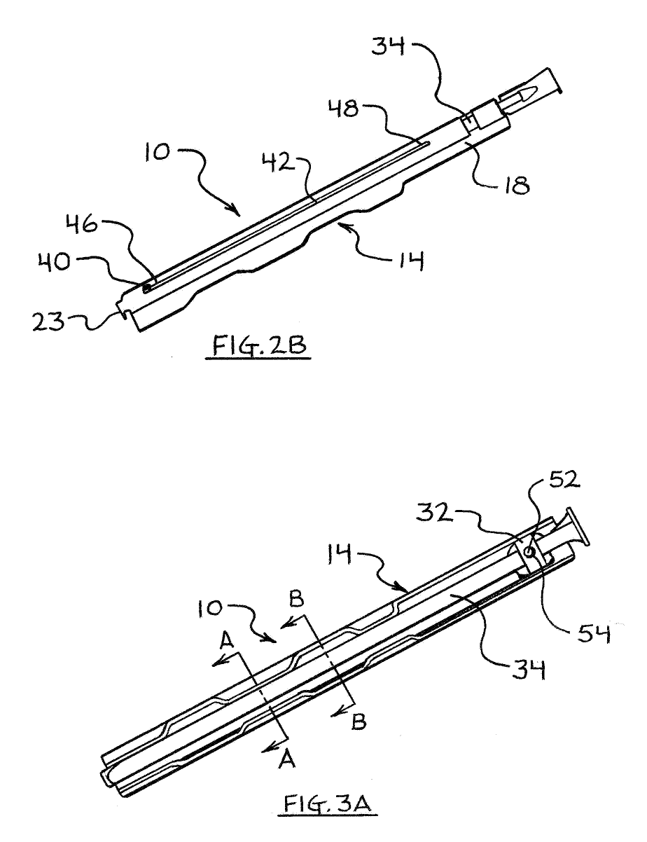

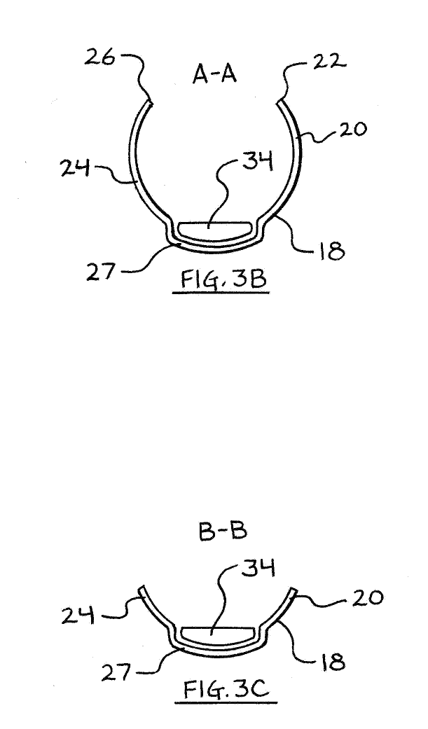

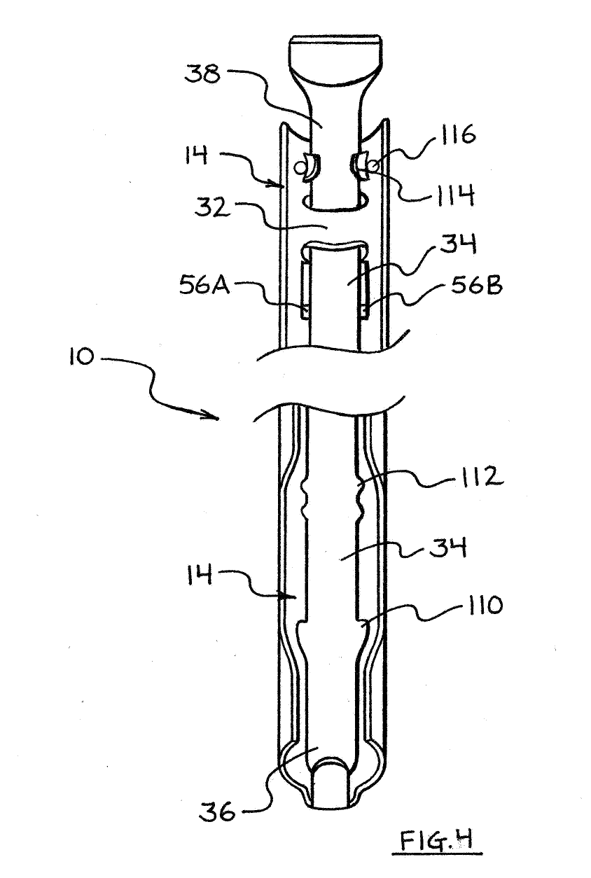

FIG. 3A illustrates an embodiment similar to FIGS. 2A and 2B, with the addition of a locking protrusion 52 located on the elongate member 34 for engaging a locking aperture 54 on the first container element 14, and specifically on the guide 32 of the first container element 14.

FIG. 3B illustrates a cross-sectional view of the first container element 14 and the elongate member 34 at a first position where the distal end 22 of the first arm 20 and the distal end 26 of the second arm 24 are fully extended for retaining or suspending containers. FIG. 3B more clearly illustrates a grove 27 formed in the base 18 of the first container element 14. This grove 27 provides a pocket of space which can be coordinated with the width and depth of the elongate member 34. In this way, the elongate member 34 can slide along back and forth within the track of the groove 27 in the first container element 14 without interfering with the generally circular cross-section formed by the interior of the base 18, the first arm 20 and the second arm 24. In this way, the groove 27 further promotes a generally circular cross section for retaining generally cylindrical containers.

In contrast, FIG. 3C illustrates another cross sectional view with less extension of the first arm 20 and the second arm 24. This section of the first container element 14 provides accessibility for putting containers into the first container element and removing containers from the first container element.

FIG. 4 illustrates an embodiment of a telescoping cryocane 10 more similar to that illustrated in FIG. 2, including an elongate member 34 with a distal end 38 and a proximal end 36 secured with a guide 32 on the first container element 14. The elongate guide 34 includes outward lateral extensions 110 towards the proximal end 36. These lateral outward extensions 110 limit the extension of the elongate member 34 relative to the first container element 14 by virtue of the vertical catches 56a, 56b. These vertical catches 56a, b provide stopping points past which the lateral outward extensions 110 cannot easily pass.

Additionally, FIG. 4 illustrates a first set of detents 112 at the proximal end 36 of the elongate member 34 and a second set of detents 114 at the distal end 38 of the elongate member 32. These detents 112, 114 mate with the internal extension 116 of the first container element. These detents 112, 114 are in the shape of ears and require a slight amount of force to engage and disengage providing relative locked positions of the elongate member 34 along the first container element 14. The first set of detents 112 can be coordinated with the first container element 14 to provide a locked position when the elongate member 32 is in the fully extended position and the second set of detents 114 can be coordinated to provide a locked position when the elongate member is in the fully retracted position (as illustrated in FIG. 4).

As can be easily understood from the foregoing, the basic concepts of the present invention may be embodied in a variety of ways. The invention involves numerous and varied embodiments of telescoping cryocanes and methods of making and using the telescoping cryocanes including, but not limited to, the best mode of the invention.

As such, the particular embodiments or elements of the invention disclosed by the description or shown in the figures accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “telescoping” element should be understood to encompass disclosure of the act of “telescoping”—whether explicitly discussed or not—and, conversely, were there effectively disclosure of the act of “telescoping”, such a disclosure should be understood to encompass disclosure of a “telescoping” element and even a “means for telescoping.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Moreover, for the purposes of the present invention, the term “a” or “an” entity refers to one or more of that entity; for example, “a telescoping cryocane” refers to one or more of the telescoping cryocanes. As such, the terms “a” or “an”, “one or more” and “at least one” can be used interchangeably herein.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes, for example, the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A telescoping cryocane for holding a container or multiple containers upright within a cryogenic container comprising:
a first container element for holding a container; and
a second container element slidably engaging the first container element in a telescoping relation, wherein the first container element and the second container element are slidable between a retracted position and an extended position.

2. The telescoping cryocane according to claim 1 wherein the first container element further comprises a base from which at least a first arm with at least a first distal end extends on one side and from which at least a second arm with at least a second distal end extends on another side, wherein at least the second arm converges towards least the first arm partially enclosing an interior space and forming a gap between at least the first distal end and at least the second distal end.

3. The telescoping cryocane according to claim 2 wherein the first distal end of the first arm and the second distal end of the second arm converge forming a substantially cylindrical interior space.

4. The telescoping cryocane according to claim 3 wherein the second container element comprises a cylindrical tubular element which is substantially located within the first container element in the retracted position and wherein each of the first container element and the second container element can each hold container when in the fully extended position.

5. The telescoping cryocane according to claim 2 wherein the first arm comprises a plurality distal ends.

6. The telescoping cryocane of claim 1 wherein the first container element further comprises at least one guide.

7. The telescoping cryocane according to claim 5 where the second container element comprises an elongate member having a proximal end and a distal end wherein the elongate member slides through the guide providing the telescoping relationship between the first container element and the second container element.

8. The telescoping cryocane according to claim 6 further comprising a stop at the proximal end and a stop at the distal end of the elongate member.

9. The telescoping cryocane according to claim 7 wherein the stop at the proximal end comprises an outward protrusion dimensioned such that the outward protrusion will not pass the guide.

10. The telescoping cryocane according to claim 7 wherein the stop at the distal end comprises an outward protrusion dimensioned such that the outward protrusion will not pass the guide.

11. The telescoping cryocane according to claim 6 wherein the first container element further comprises a longitudinal slit and the second container element further comprises a protrusion for engaging the longitudinal slit.

12. The telescoping cryocane according to claim 10 wherein the fully extended position is defined by the protrusion of the second container element hitting a first end of the slit in the first container element and the fully retracted position is defined when the protrusion in the second container element hits the second end of the slit opposite the first end.

13. The telescoping cryocane according to claim 7 further comprising a stopping mechanism.

14. The telescoping cryocane according to claim 12 wherein the stopping mechanism further comprises a locking protrusion on the elongate member which engages a locking aperture on the first container element.

15. The telescoping cryocane according to claim 13 wherein the locking protrusion and the locking aperture are aligned such that they are engaged when the telescoping cryocane is in the fully extended position.

16. The telescoping cryocane according to claim 12 wherein the stopping mechanism further comprises at least one ear acting as a stop against an extension on the elongate member of the second container element.

17. A telescoping cryocane for holding a container or multiple containers comprising:
a first container element having a base from which a first arm with a first distal end extends on a first side and from which a second arm with a second distal end extends on a second side, wherein the second arm converges towards the first arm partially enclosing an interior space and forming a gap between the first distal end and the second distal end;
a first catch formed in the first container element by an extension of the first distal end and by an extension of the second distal end forming a narrow portion of the gap;
a second container element slidably engaged with the first element in a telescoping relationship, wherein the second container element comprises a bottom attached to at least one sidewall with an exterior surface;
a guiding protrusion formed on the exterior surface of the sidewall of the second container element, the guiding protrusion comprising a narrow neck and a wide stopping portion, wherein the guiding protrusion extends past into the gap formed between the first distal end of the first arm and the second distal end of the second arm;
a stopping surface formed on the stopping portion of the guiding protrusion, wherein the stopping surface contacts the first catch when the telescoping cryocane is fully extended;
a second stopping portion formed as a flange on the bottom of the second container element wherein the flange extends past the first container element forming a fully retracted position when the flange is in contact with the first container element;
a first locking mechanism comprising a first locking aperture in the first container element which aligns with a first projection in the second container element when the second container element is fully extended relative to the first container element; and
a second locking mechanism comprising a second locking aperture in the first container element which aligns with a second projection in the second container element when the second container element is fully retracted relative to the first container element.

18. A telescoping cryocane for carrying a container or multiple containers according to claim 16 further comprising a spaced stopper formed in the interior space of the first container element.

19. A telescoping cryocane for carrying a container or multiple containers according to claim 16 wherein the first container element further comprises a top a top surface.

20. A telescoping cryocane for carrying a container or multiple containers according to claim 16 further comprising access grooves in the first arm and in the second arm providing access to containers and materials within containers while in the telescoping cryocane.

21. A system for transporting materials at low temperatures comprising:
a. a cryogenic container containing liquid nitrogen;
b. a telescoping cryocane disposed within the cryogenic container, the telescoping cryocane comprising:
i. a first container element for holding a container in the proximity of the liquid nitrogen; and
ii. a second container element slidably engaging the first container element, wherein the second container element is extended sufficiently for access from the exterior of the cryogenic container.
